(19) United States
(12) Patent Application Publication
(10) Pub. No.: US 2003/0205622 A1
(43) Pub. Date: Nov. 6, 2003

(54) Machine-readable label

(76) Inventor: Detlef Houdeau, Langenquaid (DE)

Correspondence Address: LERNER AND GREENBERG, P.A., POST OFFICE BOX 2480, HOLLYWOOD, FL, 33022-2480, US

(21) Appl. No.: 10/426,519

(22) Filed: Apr. 30, 2003

Related U.S. Application Data
(63) Continuation of application No. PCT/DE01/03013, filed on Aug. 7, 2001.

(30) Foreign Application Priority Data
Sep. 13, 2000 (DE) 100 45 196.9

(51) Int. Cl. G06K 19/06

(52) U.S. Cl. 235/492

(57) ABSTRACT

A machine-readable label has an IC chip configured on a backing film in a clearance in the adhesive layer applied to the backing film. At least one terminal contact of this IC chip is connected in an electrically conducting manner to an electrical conductor that has been applied to the backing film and that is intended as an antenna for transmitting data and energy in a contactless manner.

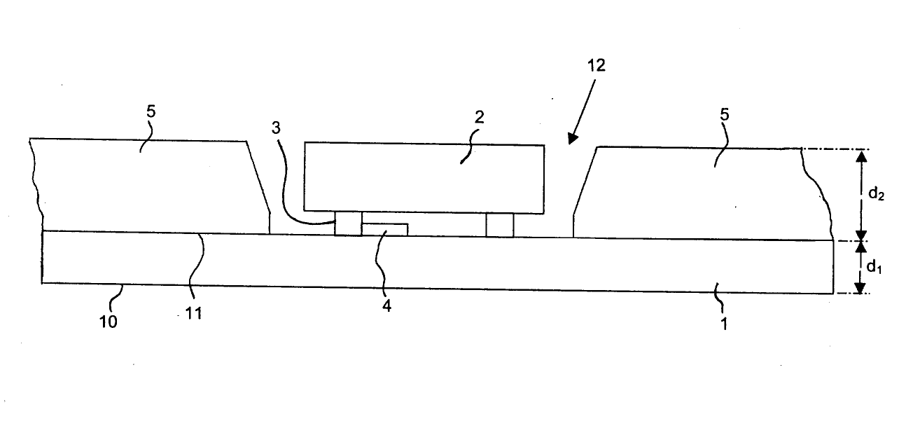

### CROSS-REFERENCE TO RELATED APPLICATION:

This application is a continuation of copending International Application No. PCT/DE01/03013, filed Aug. 7, 2001, which designated the United States and was not published in English.

### BACKGROUND OF THE INVENTION

### FIELD OF THE INVENTION

The present invention relates to a machine-readable label, in particular, a self-adhesive label that is intended for sticking onto a product.

Printed self-adhesive labels are used for product identification. The self-adhesive property of the label is achieved by providing an adhesive layer of a cold adhesive. The backing film or an adequately tear-resistant paper, intended for the label, is provided with a thin self-adhesive layer. This layer is usually applied to the non-printed rear side of the label. On the front side, there may be in principle any desired imprint, which for example, includes a barcode intended for reading out the information coded in it using an optically operating barcode reader.

Machine-readable and self-adhesive labels of this type have a number of disadvantages. It must always be ensured that the printed upper side of the label remains visible. Additional information cannot be subsequently written into the label; consequently, it is also not possible, in particular, to reconstruct the route which a product provided with the label has followed. A label of this type also has no security features. It is therefore easily possible to carry out duplication or some other manipulation. For these reasons, electronic labels, as presented in the review articles by Detlef Zienert, “Elektronische Etiketten für den richtigen Überblick” [Electronic labels for the right overview] in packung&transport, 3/1993, pages 11-12, and by Helmuth Lemme, “Das elektronische Etikett” [The electronic label] in Elektronik 19/1994, pages 126-135, are already in widespread use.

Published German Patent Application DE 199 04 928 A1 describes a method of processing transponders on a plastic film, in which a pressure is exerted onto the side surfaces of the transponder using pressing rollers or stamps to planarize protruding structures. An IC chip is arranged in a clearance in the film and is connected in an electrically conducting manner to conductors arranged on the surface of the film.

### SUMMARY OF THE INVENTION:

It is accordingly an object of the invention to provide a machine-readable label that overcomes the above-mentioned disadvantages of the prior art apparatus of this general type. In particular, it is an object of the invention to provide an improved label, in particular, for product identification, in which the mentioned disadvantages of a permanently printed-on barcode are eliminated.

With the foregoing and other objects in view there is provided, in accordance with the invention, a machine-readable label including a backing film, and an adhesive layer applied to the backing film. The adhesive layer has a clearance therein. The machine-readable label also includes an IC chip configured in the clearance of the adhesive layer, and a structured electrical conductor applied to the backing film. The electrical conductor is configured in the clearance of the adhesive layer. The IC chip has at least one terminal contact mounted on the electrical conductor. The adhesive layer is at least as thick as the IC chip.

In accordance with an added feature of the invention, the backing film is a thermoplastic film having a thickness of from 30 μm to 100 μm.

In accordance with an additional feature of the invention, the adhesive layer has a thickness of from 50 μm to 70 μm.

In accordance with another feature of the invention, the adhesive layer is a self-adhesive cold adhesive.

In accordance with a further feature of the invention: the IC chip has a surface facing away from the backing film; the surface of the IC chip lies in a plane; the adhesive layer has a surface facing away from the backing film; and the surface of the adhesive layer also lies in the plane.

In accordance with a further added feature of the invention, the surface of the IC chip and the surface of the adhesive layer adjoin one another without any gaps or steps. In accordance with yet an added feature of the invention, the surface of the IC chip and the surface of the adhesive layer adjoin one another in a flush manner.

In the inventive machine-readable label, an IC chip is arranged on a backing film in a clearance in the adhesive layer applied to it. At least one terminal contact of this IC chip is connected in an electrically conducting manner to an electrical conductor that has been applied to the backing film and is intended as an antenna for contactless transmission of data and energy.

Other features which are considered as characteristic for the invention are set forth in the appended claims.

Although the invention is illustrated and described herein as embodied in a machine-readable label, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWING:

The drawing FIGURE is a cross sectional view of a label.

### DESCRIPTION OF THE PREFERRED EMBODIMENTS:

Referring now to the sole drawing FIGURE in detail, there is shown a backing film 1 of a thickness d₁ of typically 30 μm to 100 μm (36 μm is a customary thickness for films which are suitable for the label) with the adhesive layer 5 applied to it and the IC chip 2 inserted in a clearance 12 in the adhesive layer 5. The outer side 10 of the backing film 1, facing away from the IC chip and not provided with an adhesive layer, can be printed onto before the adhesive layer 5 is applied. A material suitable for the backing film 1 is PET (polyethylene terephthalate).

The opposite side 11 of the backing film is provided with a thin layer of a structured conductor 4 of an electrically conducting material, for example, with a thin metallization, before mounting the IC chip 2. This conductor 4 is preferably applied in a structured manner using a suitable masking technique. In principle, however, it is also possible to structure an electrically conducting layer applied over the entire surface area by subsequently etching it away.

The layer is structured in such a way that it can perform the function of an antenna. If a capacitive coupling is provided, a conductor track structured in an elongate manner is sufficient. For inductive coupling, a simple magnetic coil in the form of a spirally structured conductor track is suitable. The IC chip 2 is mounted with its upper side having the active components of the integrated circuit on the conductor 4 in such a way that at least one terminal contact 3 of the IC chip 2 is connected in an electrically conducting manner to the structured conductor 4. Energy and information signals can be coupled into the circuit of the IC chip 2 via the conductor 4 acting as an antenna and information stored in the IC chip can be coupled out.

Since an adhesive layer 5 used for a self-adhesive label of this type has a thickness d₂ of typically 50 μm to 70 μm, the IC chip 2 is preferably thinned to this thickness, for example, by removing the substrate (semiconductor body) of the IC chip 2 from the rear side. This can take place, for example, by etching or CMP (chemical mechanical polishing). The adhesive layer 5 is preferably only applied after mounting the IC chip 3. With the adhesive layer 5, the rear side of the backing film 1 provided with the IC chip 2 is leveled. The adhesive layer 5 is therefore at least as thick as the IC chip 2, preferably equally thick, so that the surfaces of the IC chip 2 and the adhesive layer 5 facing away from the backing film 1 lie in the same plane. This achieves the effect that the label has a planar self-adhesive rear side, with which it can be stuck onto a planar surface of a product. For the sake of clarity, a clearance 12 in the adhesive layer 5, in which the IC chip 2 is arranged, is depicted in the figure. Preferably, however, the adhesive layer 5 is applied such that it ends flush with the IC chip, i.e. is adjacent to the IC chip without any gaps or steps. In principle, it is also possible to choose the thickness of the adhesive layer 5 or the thickness of the IC chip 2, if technically feasible, in such a way that the rear side of the IC chip 2, facing away from the backing film 1, is also covered by the adhesive layer 5, so that the IC chip is completely embedded in the adhesive layer.

The inventive label has additional advantages, without sacrificing the advantageous properties of customary labels. The film 1 used can be printed onto and provided with a self-adhesive adhesive layer 5. In addition, the IC chip 2 integrated into the label makes it possible for the label to be readable even in those cases in which the imprint is not visible or is damaged in such a way that optical recognition of the information is no longer possible. The contactless communication between the integrated circuit and a device used for reading out the information or for writing in new information using the integrated antenna increases the reliability and easy handling of the inventive label.

In further refinements of this label, the machine-readability may also be restricted to electronic readability, dispensing entirely with the printed-on barcode. The imprint may then be used for other information. In particular, a neutral design of the printable outer surface 10 of the backing film 1 is also possible. Because of the small dimensions of the IC chip 2 integrated into the label, the label does not differ in handling, or only insignificantly, from previously customary labels.

I claim:

1. A machine-readable label comprising:
a backing film;
an adhesive layer applied to said backing film, said adhesive layer having a clearance therein;
an IC chip configured in said clearance of said adhesive layer; and
a structured electrical conductor applied to said backing film, said electrical conductor configured in said clearance of said adhesive layer;
said IC chip having at least one terminal contact mounted on said electrical conductor; and
said adhesive layer being at least as thick as said IC chip.

2. The label according to claim 1, wherein said backing film is a thermoplastic film having a thickness of from 30 μm to 100 μm.

3. The label according to claim 1, wherein said adhesive layer has a thickness of from 50 μm to 70 μm.

4. The label according to claim 1, wherein said adhesive layer is a self-adhesive cold adhesive.

5. The label according to claim 1, wherein: said IC chip has a surface facing away from said backing film; said surface of said IC chip lies in a plane; said adhesive layer has a surface facing away from said backing film; and said surface of said adhesive layer also lies in said plane.

6. The label according to claim 5, wherein said surface of said IC chip and said surface of said adhesive layer adjoin one another without any gaps or steps.

7. The label according to claim 5, wherein said surface of said IC chip and said surface of said adhesive layer adjoin one another in a flush manner.
